(19) United States
(12) Patent Application Publication
(10) Pub. No.: US 2013/0081719 A1
(43) Pub. Date: Apr. 4, 2013

(54) DISPENSING APPARATUS AND SUCTION NOZZLE POSITION CONTROL METHOD

(71) Applicant: FUJIFILM Corporation, Tokyo (JP)

(72) Inventor: Toshiharu KUWAE, Kanagawa-ken (JP)

(73) Assignee: FUJIFILM CORPORATION, Tokyo (JP)

(21) Appl. No.: 13/632,484

(22) Filed: Oct. 1, 2012

(30) Foreign Application Priority Data
Sep. 30, 2011 (JP) 2011-217915

(51) Int. Cl. F17D 3/00

(52) U.S. Cl. 137/565.11

(57) ABSTRACT

A dispensing apparatus including a suction nozzle having a tip to which a nozzle chip is removably attachable, a moving mechanism for moving the suction nozzle, a suction/discharge pump for supplying a suction/discharge pressure to the suction nozzle, a pressure measurement unit for measuring a pressure in the suction nozzle, and a control unit for controlling amounts of actuation of the moving mechanism and the suction/discharge pump, wherein the suction nozzle is moved toward the surface of a dry analysis element with air being discharged from a tip of a nozzle chip attached to the suction nozzle and the movement of the suction nozzle is stopped at a time point at which the pressure in the suction nozzle is detected to have reached a value corresponding to a predetermined relative distance between the tip of the nozzle chip and the surface of the dry analysis element.

### BACKGROUND OF THE INVENTION

1. Field of the Invention

The present invention relates to a dispensing apparatus for dispensing a solution, such as a sample and the like, to a dispensing target and a suction nozzle position control method in the dispensing apparatus.

2. Description of the Related Art

In quantitative analyses and the like, a solution, such as a sample solution, is sucked and held in a nozzle chip attached to a tip of a suction nozzle and a predetermined amount of the solution is discharged and spotted on an analyzing element, mixing cup, slide, or glass. Various dispensing operations are performed, such as sequentially spotting sample and reference solutions on dry analysis elements by predetermined amounts, discharging a sample solution in a mixing cup by a predetermined amount for dilution, and the like. In such measurements, it is important to accurately discharge and spot the solution by a specified amount in order to enhance the measurement accuracy.

In the case where the target examination sample is an expensive medicine or a biological sample, such as blood, urine, or the like, it is preferable that the amount of sample solution required for measurement is reduced to several tens of micro liters.

In order to constantly supply a fixed minuscule amount of sample solution to each dry analysis element, the dispensing apparatus generally supplies a sample solution to a dry analysis element by discharging a minuscule amount of the sample solution from a tip of a nozzle chip attached to a dispensing nozzle to form a very small diameter droplet at the tip and spotting the droplet on the dry analysis element.

In this case, improper control of the relative distance between the tip of the nozzle chip and the surface of the dry analysis element may cause the amount of supply of the sample solution to be uncontrollable, and in some cases, the dry analysis element may be damaged as a result of abutment of the tip of the nozzle chip to the surface of the element or the dry analysis element may be put to measurement without the sample solution.

The shape accuracy of the disposable nozzle chip is not so high and, what is more, the nozzle chip attached to the suction nozzle and dry analysis element are moved within the apparatus, so that each of them is likely to be displaced at the position where the sample is supplied and the positional relationship between them may possibly be changed, though slightly, each time the dispensing is performed.

Thus, in order to control the relative distance between the tip of the nozzle chip and the surface of the dry analysis element with high accuracy, it is necessary to accurately measure the relative distance between them. But high accurate sensors, such as laser displacement meters and the like are very expensive, and it is difficult to employ such a sensor since the device cost is increased considerably.

Consequently, Japanese Unexamined Patent Publication Nos. 2003-254983 and 2000-074929 disclose a method for accurately detecting the surface of a sample solution by making use of a pressure sensor provided from the beginning in which the suction nozzle is moved toward the surface of the sample solution with air being discharged from the tip of the nozzle chip attached to the suction nozzle and the movement of the suction nozzle is stopped when a pressure increase in the suction nozzle is detected by the pressure sensor as a result of the tip of the nozzle chip being brought into contact with the surface of the solution and the flow of the air being stopped. But, in the case where the nozzle chip cannot be brought into contact with the dispensing target, as in the case in which a sample solution is supplied to a dry analysis element, the method disclosed in the aforementioned patent documents cannot be used directly.

In view of the circumstances described above, it is an object of the present invention to provide a dispensing apparatus capable of precisely controlling the relative distance between the tip of the nozzle chip and dispensing target object and a suction nozzle position control method in the dispensing apparatus.

### SUMMARY OF THE INVENTION

A dispensing apparatus of the present invention is an apparatus, including:

a suction nozzle having a tip to which a nozzle chip is removably attachable;

a moving mechanism for moving the suction nozzle;

a speed detection unit for detecting a moving speed of the suction nozzle moved by the moving mechanism;

a suction/discharge pump for supplying a suction/discharge pressure to the suction nozzle;

a pressure measurement unit for measuring a pressure in the suction nozzle; and

a control unit for controlling amounts of actuation of the moving mechanism and the suction/discharge pump,

wherein the control unit is a unit that controls amounts of actuation of the moving mechanism and the suction/discharge pump such that the suction nozzle is moved toward a dispensing target with air being sucked or discharged from a tip of a nozzle chip attached to the suction nozzle and the movement of the suction nozzle is stopped after a time period from a time point at which the pressure in the suction nozzle is detected to have reached a value corresponding to a predetermined relative distance L (L≠0) between the tip of the nozzle chip and the dispensing target, the time period being based on the moving speed of the suction nozzle at the time point.

A suction nozzle position control method of the present invention is a method, including the steps of:

moving a suction nozzle having a tip to which a nozzle chip is removably attachable toward a dispensing target with air being sucked or discharged from a tip of a nozzle chip attached to the suction nozzle; and

stopping the movement of the suction nozzle after a time period from a time point at which the pressure in the suction nozzle is detected to have reached a value corresponding to a predetermined relative distance L (L≠0) between the tip of the nozzle chip and the dispensing target, the time period being based on the moving speed of the suction nozzle at the time point.

In the dispensing apparatus and the suction nozzle position control method described above, the term “predetermined relative distance L” refers to a relative distance between the tip of the nozzle chip and the surface of the dispensing target detectable by a pressure change in the suction nozzle within a range that does not cause the nozzle chip to contact the dispensing target when the suction nozzle is moved toward the dispensing target with air being sucked or discharged from the tip of the nozzle chip attached to the suction nozzle. In the case where the pressure corresponding to the relative distance L is detected by the method described above, a relatively large distance between the tip of the nozzle chip and the dispensing target does not cause a change in the pressure that allows detection of the relative distance. Thus, the relative distance L is preferable to be not greater than 1 mm. Note that L=0 refers to that the nozzle chip is in contact with the dispensing target, so that the condition L≠0 is required.

The phrase “movement of the suction nozzle is stopped after a time period from a time point at which the pressure in the suction nozzle is detected to have reached a value corresponding to a predetermined relative distance L (L≠0) between the tip of the nozzle chip and the dispensing target, the period being based on the moving speed of the suction nozzle at the time point” refers to that the movement of the suction nozzle is stopped within a time in which the tip of the nozzle chip is not brought into contact with the dispensing target based on the relative distance L and the moving speed of the suction nozzle at the time point.

As for the method of detecting that the pressure in the suction nozzle has reached a value corresponding to the relative distance L when the suction nozzle is moved toward the dispensing target with air being sucked or discharged from a tip of a nozzle chip attached to the suction nozzle, the aforementioned detection may be made by detecting that the pressure in the suction nozzle exceeds a predetermined threshold value or by detecting that a pressure change slop exceeds a predetermined inclination.

According to the dispensing apparatus and the suction nozzle position control method of the present invention, a suction nozzle having a tip to which a nozzle chip is removably attachable is moved toward a dispensing target with air being sucked or discharged from a tip of a nozzle chip attached to the suction nozzle and the movement of the suction nozzle is stopped after a time period from a time point at which the pressure in the suction nozzle is detected to have reached a value corresponding to a predetermined relative distance L (L≠0) between the tip of the nozzle chip and the dispensing target, the period being based on the moving speed of the suction nozzle at the time point. In the case where the nozzle chip is not brought into contact with the dispensing target, this allows the relative distance between the tip of the nozzle chip and dispensing target to be controlled precisely and inexpensively by making use of a pressure measurement unit provided in the dispensing apparatus from the beginning.

In the case where the pressure corresponding to the relative distance L is detected by the method described above, a relatively large distance between the tip of the nozzle chip and the dispensing target does not cause a change in the pressure that allows detection of the relative distance. Thus, by setting the relative distance L to a value not greater than 1 mm, their closeness in the relative distance may be detected reliably.

### BRIEF DESCRIPTION OF THE DRAWINGS

FIG. 1 is a schematic configuration diagram of a biochemical analysis apparatus that employs a dispensing apparatus according to an embodiment of the present invention.

FIG. 2 is a schematic configuration diagram of a dispensing mechanism (dispensing apparatus) of the biochemical analysis apparatus described above.

FIG. 3 is an enlarged view adjacent to the dispensing apparatus of the biochemical analysis apparatus described above.

FIG. 4 is a graph illustrating a pressure change in the suction nozzle during relative distance control between the tip of the nozzle chip and the dispensing target.

### DESCRIPTION OF THE PREFERRED EMBODIMENTS

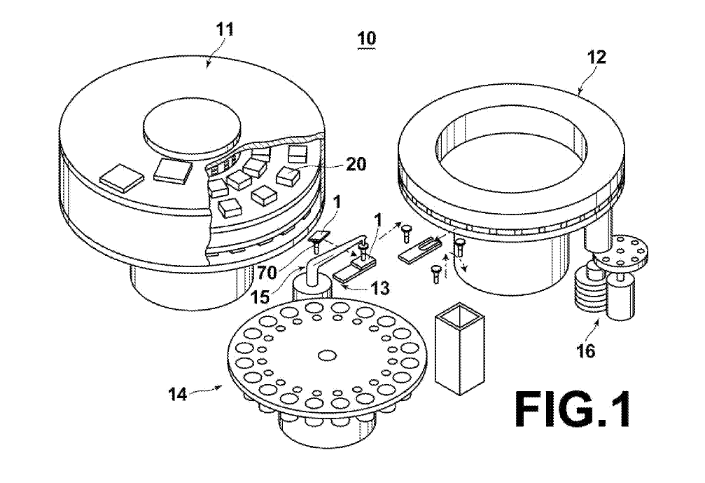

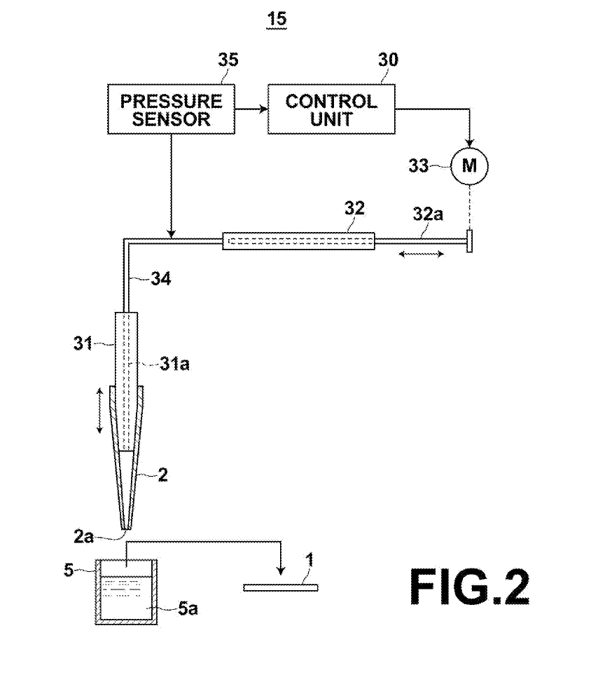

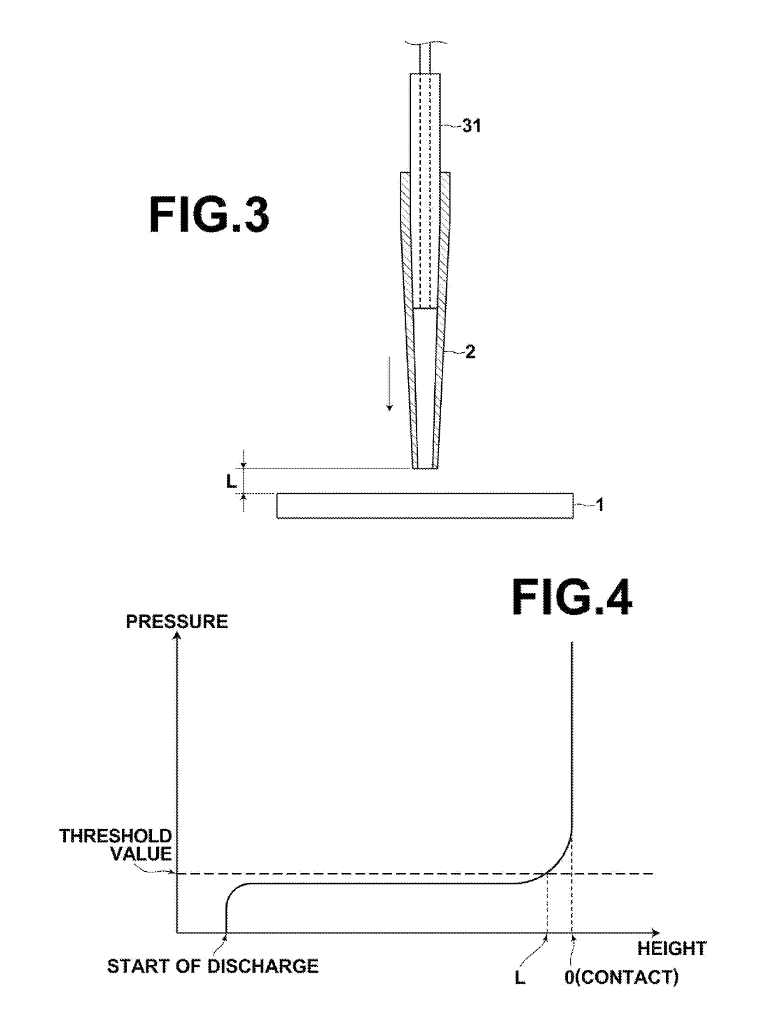

Hereinafter, a biochemical analysis apparatus that employs a dispensing apparatus according to an embodiment of the present invention will be described with reference to the accompanying drawings. FIG. 1 is a schematic configuration diagram of a biochemical analysis apparatus that employs a dispensing apparatus according to an embodiment of the present invention. FIG. 2 is a schematic configuration diagram of a dispensing mechanism (dispensing apparatus) of the biochemical analysis apparatus. FIG. 3 is an enlarged view adjacent to the dispensing apparatus of the biochemical analysis apparatus described above. FIG. 4 is a graph illustrating a pressure change in the suction nozzle during control of the relative distance between the tip of the nozzle chip and the dispensing target.

The biochemical analysis apparatus 10 includes a dry analysis element supply unit 11 (supplier) storing a plurality of cartridges 20, each stack-accommodating unused substantially square or rectangular dry analysis elements 1, an incubator 12 disposed on a side of the dry analysis element supply unit 11 and maintains a dry analysis element 1 having a sample solution spotted thereon at a constant temperature for a predetermined time, a film conveyance mechanism 13 that conveys a dry analysis element 1 from the dry analysis element supply unit 11 to the incubator 12 by sucking it with a suction disk 70, a sample solution accommodation unit 14 (sampler) for accommodating a plurality of sample solutions, for example, serum, urine, and the like, a dispensing mechanism (dispensing apparatus) 15 for spotting a sample solution sucked from the sample solution accommodation unit 14 on a dry analysis element 1 before it is conveyed to the incubator 12 by the film conveyance mechanism 13, and a photometric unit 16 (optical photometric unit) disposed under the incubator 12.

For more information about the biochemical analysis apparatus 10 other than the dispensing mechanism 15, refer to U.S. Pat. No. 5,928,951 (EP 0 634 657A) disclosed by the present applicant. The dispensing mechanism of the biochemical analysis apparatus 10 will be described in detail later. The dry analysis element 1 is an element (chip) having a reaction layer stacked, by application, bonding, or the like, on an optically transparent support layer of a plastic sheet, such as an organic polymer sheet of polyethylene terephthalate (PET), polystyrene, or the like, and a spreading layer stacked on the reaction layer by lamination or the like.

The reaction layer includes at least one layer of a hydrophilic polymer binder, such as gelatin, or a porous layer such as a filter paper, cloth, or microporous polymer sheet in which a detection reagent selectively reacts with an analyte and a reagent (chemical analysis reagent or immune analysis reagent) required for a chromogenic reaction are included.

The spreading layer is formed of a material externally resistant to abrasion, such as woven fabric, knit fabric of synthetic fiber of polyester or the like, woven fabric, knit fabric, unwoven fabric of a blend of natural and synthetic fibers, or otherwise paper to function as a protection layer and extended such that a sample solution spotted thereon is uniformly supplied to the reaction layer.

The dispensing mechanism 15 includes a suction nozzle 31 and a pipette-like nozzle chip 2 designed to be removably and replaceably attached to a tip of the suction nozzle 31 to hold a liquid. The suction nozzle 31 includes an air passage 31a in the center passing along an axial direction and opens at the tip, and an air circuit 34 from a suction/discharge pump 32 is connected to the air passage 31a.

The suction pump 32 is a pump that generates negative and positive pressures with little pulsation, such as a syringe pump or the like, and is driven by a pump drive unit (motor) 33. In the case of the suction/discharge pump 32 of a syringe pump shown in FIG. 2, a piston member 32a is moved according to normal and reverse rotation drives to generate a negative pressure (suction pressure) and a positive pressure (discharge pressure) which are guided to the inside of the nozzle chip 2 by the air circuit 34 via the air passage 31a in the suction nozzle 31.

The operation of the suction nozzle 31 is controlled by vertically and horizontally movably attached to a moving mechanism (not shown), such as a lifting /rotating mechanism. Further, the vertical moving speed of the suction nozzle 31 is detected by a speed detection unit (not shown).

The nozzle chip 2 has a pipette-like shape as a whole and includes a tip opening 2a at the lower end for sucking/discharging a liquid which is held in a volume communicating with the opening 2a. The upper side of the nozzle chip 2 is tightly fitted to a tip portion of the suction nozzle 31 in which the tip portion is inserted into the nozzle chip 2 by a downward movement of the suction nozzle 31 and nozzle chip 2 is attached and held by the fitting forth. The pressure in the air passage 31a is guided to the nozzle chip 2 and a liquid is sucked into the inside of the nozzle chip 2 if the pressure is a suction pressure while a liquid inside of the nozzle chip 2 is discharged if the pressure is a discharge pressure. The nozzle chip 2 after use is removed and discarded.

The operation of the suction/discharge pump 32 is controlled by a drive signal sent from a control unit 30 to the pump drive unit 33.

The control unit 30 receives a pressure signal from a pressure sensor 35 that measures a pressure in the suction nozzle 31 (more precisely, a pressure in the air circuit 34 communicating with the suction nozzle 31). The control unit 30 also receives a signal representing a moving speed of the suction nozzle 31 from the speed detection unit.

Control of relative distance between the tip of nozzle chip 2 and dry analysis element 1 by the control unit 30 will now be described.

The shape accuracy of the disposable nozzle chip 2 is not so high and, what is more, the nozzle chip 2 attached to the suction nozzle 31 and dry analysis element 1 are moved within the apparatus, so that each of them is likely to be displaced at the position where a sample is supply and the positional relationship between them may possibly be changed, though slightly, each time the dispensing is performed. Thus, high precision relative distance control may not be performed unless relative distance control reflecting the relative positional relationship between the tip of the nozzle chip 2 and the dry analysis element 1 is performed at the start of each dispensing operation.

Consequently, it is conceivable that the movement of the suction nozzle 31 is stopped when a pressure corresponding to a relative distance L between the tip of the nozzle chip 2 and the dry analysis element 1 is detected by the pressure sensor 35. It may take a little time to stop the suction nozzle 31 from the time when an instruction to stop the suction nozzle 31 is issued after the pressure reaches a specific value. Consequently, depending on the moving speed of the suction nozzle 31 and the distance between the suction nozzle 31 and the dry analysis element 1, the suction nozzle 31 may possibly contact the dry analysis element 1 by the movement of the suction nozzle 31 during the period from the time when the movement of the suction nozzle 31 is stopped in the manner described above and the time when the suction nozzle 31 is actually stopped.

Consequently, in the present embodiment, relative distance control is performed in which the suction nozzle 31 is moved toward the dry analysis element 1 (moved downward from above in the drawing) with air being discharged from the tip of the nozzle chip 2 attached to the suction nozzle 31, as illustrated in FIG. 3, then the suction nozzle 31 is started to be slowed down at a time point at which the pressure in the suction nozzle 31 is detected to have reached a value corresponding to the relative distance L between the tip of the nozzle chip 2 and the dry analysis element 1 by the pressure sensor 35, and the suction nozzle is stopped within a time period according to the moving speed of the suction nozzle at the time point.

Here, a pressure change in the suction nozzle during relative distance control will be described. FIG. 4 is a graph illustrating a pressure change in the suction nozzle during relative distance control between the tip of the nozzle chip and the dispensing target. The vertical axis of the graph represents the pressure which increases as the position on the axis moves upward. The horizontal axis of the graph represents the height of the tip of the nozzle chip from the surface of the dry analysis element (relative distance) which decreases as the position on the axis moves right direction.

In the case where the suction nozzle 31 is moved toward the dry analysis element with air being discharged from the tip of the nozzle chip 2, the pressure value in the suction nozzle 31 does not vary for a certain time from the start of the discharge, but as the suction nozzle 31 draws near the surface of the dry analysis element 1, the pressure value starts to increase and, when the tip of the nozzle chip 2 is completely brought into contact with the surface of the dry analysis element 1 (position at 0 in the graph), the pressure value increases (saturates) rapidly.

As pressure values during the time period from the time when the pressure value starts to increase and the time when the tip of the nozzle chip 2 is completely brought into contact with the surface of the dry analysis element 1 correspond to relative distances between the tip of the nozzle chip 2 and the surface of the dry analysis element 1, the pressure value corresponding to the predetermined relative distance L may be obtained in advance and the pressure value may be set as the threshold value.

In the case where the pressure corresponding to the relative distance L is detected by the method described above, a relatively large distance between the tip of the nozzle chip 2 and the surface of the dry analysis element 1 does not cause a change in the pressure value that allows detection of the relative distance. Thus, by setting the relative distance L to a value not greater than 1 mm, their closeness in the relative distance may be detected reliably. On the other hand, too small distance causes too sharp change in the pressure value, thereby making it difficult to perform accurate control. As such, the relative distance L is set to 0.5 mm in the present embodiment.

When the suction nozzle 31 is moved toward the dry analysis element 1 with air being discharged from the tip of the nozzle chip 2, this allows accurate detection that the relative distance between the tip of the nozzle chip and the surface of the dry analysis element is 0.5 mm when the pressure value in the suction nozzle 31 exceeds the threshold value. At this time, taking the downward moving speed of the suction nozzle 31 as “V”, if, for example, the movement of the suction nozzle 31 is stopped within a time T=0.5/V, the relative distance may be made less than 0.5 mm without bringing the tip of the nozzle chip 2 in contact with the surface of the dry analysis element 1. More precisely, since “V” decreases as the downward speed of the suction nozzle 31 is slowed down, the travel distance of the suction nozzle 31 needs to be calculated by taking into account the variation of “V” in order to accurately calculate the relative distance between the tip of the nozzle chip 2 and the surface of the dry analysis element 1. But, as the “V” never increases, if the suction nozzle 31 is stopped within the time T=L/V at the latest, the contact between the tip of the nozzle chip 2 and the surface of the dry analysis element may be avoided.

After storing the position where the suction nozzle 31 is stopped, the control unit 30 causes the suction nozzle 31 to move above a sample solution pot 5 of the sample solution accommodation unit 14 to suck a sample solution 5a, and causes the nozzle 31 to move above the dry analysis element 1 and then down to the stored position.

In this state, the sample solution 5a is spotted on the dry analysis element 1, so that a fixed minuscule amount of the sample solution 5a can be constantly supplied to dry analysis elements 1.

As described above, the dry analysis element 1 supplied with the sample solution 5a is held in the incubator 12 for incubation and measurement is performed by the photometric unit 16 disposed under the incubator 12. The photometric unit 16 includes a photometric head for measuring optical density as a result of reaction between the dry analysis element 1 and the sample solution. The photometric head is designed to project measuring light L which includes light of a predetermined wavelength onto the reaction layer through the optically transparent support layer and detect light scattered/reflected from the dry analysis element 1 with a photo-detection element, in which the photometric head receives light from a light source and the light is projected onto the reaction layer within the photometric head.

The diffusely reflected light scattered/reflected from the dry analysis element 1 represents optical information (more specifically, light intensity) according to the amount of dye produced in the reaction layer, and the diffusely reflected light representing the optical information is incident on the photo-detection element of the photometric head where it is photoelectrically converted and outputted to a substance concentration determination unit (not shown) via an amplifier. In the substance concentration determination unit, optical density of the dye produced in the reaction layer is determined based on the level of the inputted electrical signal . Then, using a standard curve which is a conversion function from optical density to substance concentration (activity value), a calculation is performed for determining the substance concentration of a predetermined biochemical substance in the sample solution.

So far, a preferable embodiment of the present invention has been described, but it is to be understood that the present invention is not limited to the embodiment described above.

For example, the method for detecting that the pressure in the suction nozzle has reached a value corresponding to the relative distance L is not limited to the aforementioned method in which it is detected that the pressure in the suction nozzle exceeds a predetermined threshold value, and a method in which it is detected that the slope of pressure change exceeds a predetermined inclination may also be used.

Further, when controlling the relative distance, the suction nozzle 31 may be moved toward the dry analysis element 1 with air being sucked from the tip of the nozzle chip 2.

Obviously, various changes and modifications may be made without departing from the spirit and scope of the present invention other than that described above.

What is claimed is:

1. A dispensing apparatus, comprising:
a suction nozzle having a tip to which a nozzle chip is removably attachable;
a moving mechanism for moving the suction nozzle;
a speed detection unit for detecting a moving speed of the suction nozzle moved by the moving mechanism;
a suction/discharge pump for supplying a suction/discharge pressure to the suction nozzle;
a pressure measurement unit for measuring a pressure in the suction nozzle; and
a control unit for controlling amounts of actuation of the moving mechanism and the suction/discharge pump,
wherein the control unit is a unit that controls amounts of actuation of the moving mechanism and the suction/discharge pump such that the suction nozzle is moved toward a dispensing target with air being sucked or discharged from a tip of a nozzle chip attached to the suction nozzle and the movement of the suction nozzle is stopped after a time period from a time point at which the pressure in the suction nozzle is detected to have reached a value corresponding to a predetermined relative distance L (L≠0) between the tip of the nozzle chip and the dispensing target, the time period being based on the moving speed of the suction nozzle at the time point.

2. The dispensing apparatus of claim 1, wherein the relative distance L is not greater than 1 mm.

3. A suction nozzle position control method, comprising the steps of:
moving a suction nozzle having a tip to which a nozzle chip is removably attachable toward a dispensing target with air being sucked or discharged from a tip of a nozzle chip attached to the suction nozzle; and
stopping the movement of the suction nozzle after a time period from a time point at which the pressure in the suction nozzle is detected to have reached a value corresponding to a predetermined relative distance L (L≠0) between the tip of the nozzle chip and the dispensing target, the time period being based on the moving speed of the suction nozzle at the time point.

4. The suction nozzle position control method of claim 3, wherein the relative distance L is not greater than 1 mm.
